(19) United States
(12) Patent Application Publication
(10) Pub. No.: US 2026/0026919 A1
(43) Pub. Date: Jan. 29, 2026

(54) SPACER FOR ACQUIRING A VIEW OF THE MOUTH OF A USER COMPRISING ELASTICALLY DEFORMABLE WINGS

(71) Applicant: DENTAL MONITORING, PARIS (FR)

(72) Inventors: Thomas PELLISSARD, MAISONS-ALFORT (FR); Cédric LANÇON, VILLERS FARLAY (FR); Louis-Charles ROISIN, PARIS (FR)

(21) Appl. No.: 18/996,596

(22) PCT Filed: Jul. 19, 2023
(86) PCT No.: PCT/EP2023/070009

§ 371 Date: Jan. 17, 2025

(30) Foreign Application Priority Data
Jul. 22, 2022 (FR) FR2207540

(51) Int. Cl. A61C 9/00

(52) U.S. Cl. CPC A61C 9/0093; A61C 9/0053

(57) ABSTRACT

The invention relates to a spacer (1, 1′, 1″, 1″′) comprising: —a tubular portion (3) having a longitudinal axis (X); —a support assembly (7) attached to the tubular portion comprising two wings (9) having free ends (11), the support assembly being elastically deformable when pressure is applied to the wings in the direction of the longitudinal axis so as to rotate the free ends about a center of rotation (R) between a rest configuration in which the distance between the free ends is at its maximum and a contracted configuration, the center of rotation of the free ends being located, in the rest configuration, at a distance from the edge, measured in a direction parallel to the longitudinal axis, of 2 cm or less, preferably 1 cm or less or 0.5 cm or less.

### TECHNICAL FIELD

The present invention relates to the field of acquiring representations of the mouth of a user. The invention relates more particularly to a spacer for retracting the cheeks of a user in order to facilitate the acquisition of representations of teeth, in particular dental photos.

2D or 3D representations of teeth can be, in particular, extraoral images or three-dimensional digital models.

### PRIOR ART

PCT/EP2015/074897 discloses an acquisition kit enabling a users to acquire, by means of a mobile phone, extraoral photos of their teeth, with the mouth closed or the mouth open, in different orientations.

However, the dimensions of the mouth of the user can vary considerably based on their morphology, notably based on their age. If users do not use an acquisition kit adapted to the dimensions of their mouth, acquisition is not comfortable and photos may be of poor quality.

A spacer as implemented in this application is rigid and the edges thereof tend to protrude from the mouth of the user, notably if the user tries to take a side view of the teeth. The retraction of the cheeks is also not optimal.

There is therefore a need to improve existing cheek retraction solutions, notably to provide greater comfort of use and ease of application, as well as to allow the acquisition of better quality tooth representations.

One aim of the present invention is to, at least partially, meet this need.

### DISCLOSURE OF THE INVENTION

To this end, the invention relates to a spacer designed for acquiring, with an image acquisition device, 2D or 3D representations of teeth of a user, comprising:
a tubular portion having a longitudinal axis, and
a support assembly attached to the tubular portion, comprising at least one edge defining an oral opening and at least two wings comprising free ends for retracting the cheeks of a user, the support assembly being elastically deformable when pressure is applied to the wings in the direction of the longitudinal axis between a rest configuration wherein the distance between the free ends of the wings is at its maximum and a contracted configuration wherein the distance between the free ends of the wings is less than that of the rest configuration, preferably less than 1 cm or more, 2 cm or more or 4 cm or more.

A spacer according to the invention may comprise one or more of the following features:
the support assembly is one-piece.
the wings comprise a section of reduced width between the base of the wings and the free end thereof. The reduced-width section is designed to fit between the teeth and the corners of the mouth in the service position of the spacer and, preferably, its minimum width is less than 90%, 80% or 60% and/or greater than 40% or 50% of the maximum width of the wing.
the wings are rigid.
the wings are elastically deformable.
the wings comprise a core coated with one layer.
the edge is made of a flexible material, preferably an elastomer.
the support assembly comprises an elastic return member configured to hold the wings in the rest configuration in the absence of application of an external force. In other words, the elastic return member is configured to exert a return force tending to place the wings in the rest configuration.
the tubular portion comprises a hollow passage configured to receive an image acquisition device in an acquisition position wherein the image acquisition device has at least a partial view of the oral opening. Preferably, the hollow passage comprises an opening on the outer surface of the tubular portion.
the spacer is configured to receive and hold a mobile phone, preferably releasably, optionally via an adapter, the mobile phone being attached to the spacer so that the image acquisition device of the mobile phone has at least a partial view of the oral opening.
the support assembly is made of an elastically deformable material with a Shore A hardness of between 50 and 100, preferably between 65 and 80. The elastically deformable material can be a thermoplastic elastomer known as “TPE”, notably a thermoplastic rubber known as “TPR”, such as styrene-butadiene-styrene, or a thermoplastic polyurethane known as “TPU”. This advantageously allows the support assembly to be elastically deformed in the vertical direction in the service position, making it easier to position the support assembly between the lips of the user and improving comfort. CL According to a First Main Aspect

The support assembly is elastically deformable when pressure is applied to the wings in the direction of the longitudinal axis so as to rotate the free ends of the wings about a center of rotation, the center of rotation of the free ends being located, in the rest configuration, at a distance from the edge, measured in a direction parallel to the longitudinal axis, of less than or equal to 2 cm, preferably less than or equal to 1 cm or 0.5 cm.

Positioning the center of rotation close to the edge, and therefore to the oral opening, facilitates the rotational movement of the wings and also minimizes the risks of accidental removal of the wings from the mouth of the user, notably when the spacer is moved laterally in the mouth.

The spacer may comprise one or more of the following optional features:
the center of rotation of the free ends is located along the longitudinal axis.
the distance between the center of rotation and the edge, measured along the longitudinal axis, is less than or equal to 2 cm, 1 cm or 0.5 cm.
the center of rotation is located in front of the oral opening, outside the spacer, in a space between the wings and the edges.
in the service position, the center of rotation is located in the mouth of the user or between the lips of the user.

### According to a Second Main Aspect

The support assembly comprises at least two parts, each supporting a wing and attached to the tubular portion by a first pivot connection allowing a relative movement of the wings with respect to the tubular portion.

Optionally, the support assembly comprises two first parts attached to the tubular portion by the first pivot connection and two second parts each attached to a first part by a second pivot connection allowing a relative movement between the first parts and the second parts, the second parts supporting the wings, the first and second parts each preferably being one-piece.

### According to a Third Main Aspect

The support assembly comprises two parts each supporting a wing, F at least one edge connecting the two parts and comprising a flexible section configured to be elastically deformable when pressure is applied to the wings in the direction of the longitudinal axis.

Optionally, the support assembly comprises an elastic return member configured to increase the rigidity of the flexible section, the elastic return member preferably being a member made of elastomer, preferably arranged in an opening in the support assembly adjacent to the flexible section of the edge. The elastic return member is configured to maintain the wings in the rest configuration in the absence of application of an external force. In other words, the elastic return member is configured to exert a return force tending to place the wings in the rest configuration.

Preferably, the flexible section has a reduced thickness with respect to the thickness of the edge outside the flexible section, notably less than 50%, 30% or 10% of the maximum thickness of the edge. The thickness is preferably measured along the longitudinal axis or along a radial direction from the longitudinal axis.

### According to a Fourth Main Aspect

The support assembly comprises rods configured to be inserted and to slide into housings in the tubular portion.

The spacer may comprise one or more of the following optional features:
the rods are curved in the direction of the longitudinal axis, preferably having a shape of an arc, in particular a circular arc defining a circular sector with an angle greater than 20°, 30° or 45° and/or less than 90°, 80° or 60°.
the rods are greater than or equal to 3 cm, preferably to 5 cm, and/or less than or equal to 10 cm, preferably to 6 cm.
the rods comprise slotted free ends each defining two branches elastically deformable between a rest configuration wherein the branches are spaced apart and a contracted configuration wherein the branches are in contact.
in their rest configuration, the branches are spaced apart so as to form an abutment against the inner wall of the housings.
the housings pass through the wall of the tubular portion.
the housings have a flared shape, the diameter of the opening of the housings on the outer surface of the wall of the tubular portion being smaller than the diameter of the opening of the housings on the inner surface of the wall of the tubular portion.
the rods are elastically deformable and, in the rest configuration of the spacer, the rods are elastically deformed so as to exert a force on at least part of the walls of the housings. This advantageously allows the spacer to be pressed against the tubular portion.
the support assembly is elastically movable with respect to the tubular portion along two axes of rotation, preferably along three axes of rotation, by elastic deformation of the rods and/or by displacement of the rods in the housings.
the spacer comprises an elastic return member configured to maintain the support assembly on the tubular portion in a predefined rest position in the absence of application of an external force.

### According to a Fifth Main Aspect

The edge comprises a central section of reduced thickness or devoid of material, the central section being configured to be inserted between the lips and the incisors of the user.

According to this aspect of the invention, in the service position of the spacer, the lower and/or upper lips of the user are separated exclusively by lateral sections of the edge inserted between the lips and the teeth of the user adjacent to the incisors. The central section, having a reduced or non-existent thickness, does not separate the lips.

### According to a Sixth Main Aspect

The support assembly comprises at least one attachment rod extending towards the tubular portion and comprising a through-opening configured to receive an attachment pin of the tubular portion.

Thus, the attachment pin is inserted into the attachment rod, which allows the support assembly to be attached to the tubular portion.

The spacer may comprise one or more of the following optional features:
the support assembly comprises two attachment rods, preferably diametrically opposed, preferably along the vertical direction in the service position or along the alignment axis of the wings.
the attachment rod is made of an elastically deformable material and the attachment pin comprises a main section with a diameter less than or equal to the width of the opening in the attachment rod and a free end with a diameter greater than the width of the opening in the attachment rod. The attachment pin is inserted into the attachment rod by deforming the attachment rod to allow the free end to pass through. The attachment rod returns to its initial shape once the attachment pin has been inserted. Advantageously, the larger diameter of the free end allows the pin to be held securely in the opening in the rod and therefore improves the attachment of the support assembly to the tubular portion. Preferably, the diameter of the free end is less than twice the width of the opening in the attachment rod and/or greater than 1.1 times the width of the opening in the attachment rod. Preferably, the attachment pin and the free end thereof are cylindrical. If the cross-section of the main section and/or the free end are not circular, the diameter corresponds to the diameter of the smallest circle circumscribing the cross-section.
the elastically deformable material is a material with a Shore A hardness of between 50 and 100, preferably between 65 and 80, being for example a thermoplastic elastomer known as “TPE”, notably a thermoplastic rubber known as “TPR”, such as styrene-butadiene-styrene, or a thermoplastic polyurethane known as “TPU”.
the opening in the attachment rod is substantially rectangular in shape, preferably elongated in a direction parallel to the longitudinal axis, and preferably has a length along the longitudinal axis greater than the diameter of the main section of the attachment pin, preferably greater than two, three, four or five times this diameter. This advantageously allows the support assembly to be rotated with respect to the tubular portion without the attachment pin interfering with this rotational movement since the pin can be moved in translation along the opening in the rod.
the attachment pin is arranged on the outer surface of the tubular portion.

Of course, the features, whether optional or not, that define the main aspects hereinbefore are preferably combined with one another.

The invention also relates to a method for acquiring a 2D or 3D representation by means of a spacer according to the invention, said method comprising the following steps:
a) partial insertion, by the user, of the spacer into the mouth of the user to a service position wherein the image acquisition device has a view of the teeth of the user through the oral opening, the wings of the spacer separating the lips of the user to expose said teeth;
b) activation, preferably by the user, of the image acquisition device so as to acquire said 2D or 3D representation;
c) modification of the positioning of the oral opening relative to the user, by rotation around the user, and/or modification of the positioning of the tubular portion relative to the support assembly, then return to step b).

### Definitions

The “service position” is the position wherein the oral opening of the spacer extends into the mouth of the user.

The “service configuration” is the configuration of the spacer in the service position.

The “rest configuration” is the configuration of the spacer when it is under no stress other than gravity and the corresponding reaction. Unless otherwise indicated, all spacer dimensions are measured in the rest configuration.

The “contracted configuration” is a configuration of the spacer when it undergoes a set of stresses tending to bring the free ends of the wings closer together, without breaking the spacer.

A “portion” is a fraction of the tubular part delimited by two planes perpendicular to the axis X. A portion is “deformable” or “non-deformable” depending on whether or not it deforms when a user compresses it between his fingers, without breaking it. Deformation is a change in the shape of the portion that modifies the internal volume of said portion, and in particular reduces it. Deformation of a deformable portion may, for example, lead to a reduction of more than 1%, more than 2%, more than 5%, preferably more than 10%, preferably more than 20% and/or less than 40%, preferably less than 30% of the internal volume of this portion. Deformation is preferably elastic.

An object is “elastically mobile” if its position relative to a reference, for example another object, can be modified by the action of a force and if, when this force ceases, it returns to its initial position. A wing elastically curls up a lip insofar as it returns to its initial position with respect to the tubular portion when the action of the lip thereon ceases. In other words, the wing is elastically movable with respect to the tubular portion.

An object is “elastically deformable” if its shape can be modified under the action of a force and if, when this force ceases, it returns to its initial shape. A support assembly can be elastically deformable by displacing one part of the support assembly with respect to another part of said assembly and/or by deforming a one-piece part of the assembly.

By “one-piece element”, it is understood that the element is made up of a single piece.

The “mouth closed” position is the occlusion position wherein the user's upper and lower teeth are in contact. An “open mouth” position is one wherein the user's upper and lower teeth are not in contact, preferably the position with the mouth fully open.

An “image acquisition device” is a device comprising an optical lens capable of acquiring photos and/or films and/or three-dimensional digital models.

This may be an optical sensor, a camera or else a scanner. An image acquisition device can be used to acquire 2D or 3D “extraoral” representations, that is, without the optical lens being inserted into the mouth of the user or “intraoral”.

A “mobile phone” is a device typically weighing less than 500 g and equipped with an image acquisition device. A mobile phone is further capable of exchanging data with another device more than 500 km away from the mobile phone.

A “2D representation” and a “3D representation” are digital objects in two or three dimensions, respectively, acquired by a mobile phone, through the optical lens of the mobile phone. The “2D representations” acquired by the mobile phone are images, in particular conventionally photos and films. The “3D representations” acquired by the image acquisition device are three-dimensional digital models, or “3D models”.

An “image” refers to a two-dimensional image, such as a photograph. An image is made up of pixels. A “film” is considered to be a collection of photos.

A 3D model is made up of a set of voxels.

A “user” refers to a person who uses a spacer according to the invention to acquire a 2D or 3D representation of at least part of his teeth, whether or not this person is ill, or whether or not this person is undergoing orthodontic treatment. Unless otherwise indicated, qualifiers used to define positions or orientations in space, such as “horizontal”, “vertical”, “bottom”, “top”, “upper”, “lower”, “right” or “left”, are defined, for the sake of clarity, referring to a service position observed by a user, with his head upright and his lips around the oral opening of the spacer. For example, a vertical axis is an axis which is vertical in the service position.

For the sake of clarity, the orthonormal coordinate system (OXYZ) is a coordinate system such that, in the service position, the X axis extends horizontally and perpendicularly to the general plane of the oral opening, the Z axis extends vertically, and the Y axis extends perpendicularly to the X and Z axes. For the user, the X, Y and Z axes are therefore front-to-back, right-to-left, and vertical axes, respectively.

The axis of an opening is the axis that passes through its center, perpendicular to the general plane of the opening.

First and second straight lines are said to be perpendicular to one another when first and second planes perpendicular to said first and second straight lines, respectively, are perpendicular to one another.

“Attaching” one part to another means establishing a physical connection between the two, so that any movement of one part will eventually cause the other to move. A part mounted in translation, in rotation or on a swivel on another part is “attached” to this other part. An attachment can be “permanent” or “releasable”, depending on whether or not the two parts are suitable for disassembly, preferably by hand, by a user. A fastener can be rigid or non-rigid, depending on whether or not it allows relative movement of the two parts which are attached to one another. An element that is integral with another is considered to be “attached” on this other element.

### BRIEF DESCRIPTION OF THE FIGURES

FIG. 1 shows a spacer according to a first embodiment of the invention, seen from the side in the rest configuration.

FIG. 2 shows the spacer of FIG. 1 according to a perspective view.

FIG. 3 shows the spacer of FIG. 1 according to a front view.

FIG. 4 shows the spacer of FIG. 1 in a partially contracted configuration.

FIG. 5 shows a spacer according to a second embodiment of the invention.

FIG. 6 shows the spacer of FIG. 5 according to a front view.

FIG. 7 shows the spacer of FIG. 5 in a contracted configuration.

FIG. 8 is a diagram showing a spacer according to a third embodiment of the invention in cross-sectional view.

FIG. 9 is a side view of the spacer of FIG. 8.

FIG. 10 is a front view of the spacer of FIG. 8.

FIG. 11 shows the spacer of FIG. 8 in a contracted configuration.

FIG. 12 shows the spacer of FIG. 8 in a configuration where the support assembly is moved with respect to the tubular portion.

FIG. 13 is a perspective view of the support assembly of the spacer of FIG. 8.

FIG. 14 is a cross-sectional view of the spacer of FIG. 8.

FIG. 15 is a top view of the view of FIG. 14.

FIG. 16 shows two superimposed views of the spacer of FIG. 5, highlighting the position of the center of rotation of the free ends of the wings.

FIG. 17 shows two superimposed views of the spacer of FIG. 8, highlighting the position of the center of rotation of the free ends of the wings.

FIG. 18 shows a spacer according to a fourth embodiment of the invention.

FIG. 19 is a schematic side view of the spacer of FIG. 18.

FIG. 20 shows the tubular portion of the spacer of FIG. 18.

FIG. 21 shows the support assembly of the spacer of FIG. 18.

FIG. 22 is a side view of the spacer of FIG. 18.

FIG. 23 is a side view of the spacer of FIG. 18, with the support assembly rotated with respect to the tubular portion.

FIG. 24 shows a variant of the spacer according to the fourth embodiment, with the position of the attachment rods and attachment pins being different.

FIG. 25 is a schematic side view of the spacer of FIG. 24.

FIG. 26 shows the tubular portion of the spacer of FIG. 24.

FIG. 27 shows the support assembly of the spacer of FIG. 24.

FIG. 28 is a side view of the spacer of FIG. 24.

FIG. 29 is a side view of the spacer of FIG. 24, with the support assembly rotated with respect to the tubular portion.

### DETAILED DESCRIPTION

In the various figures, identical or similar components have been designated with identical references.

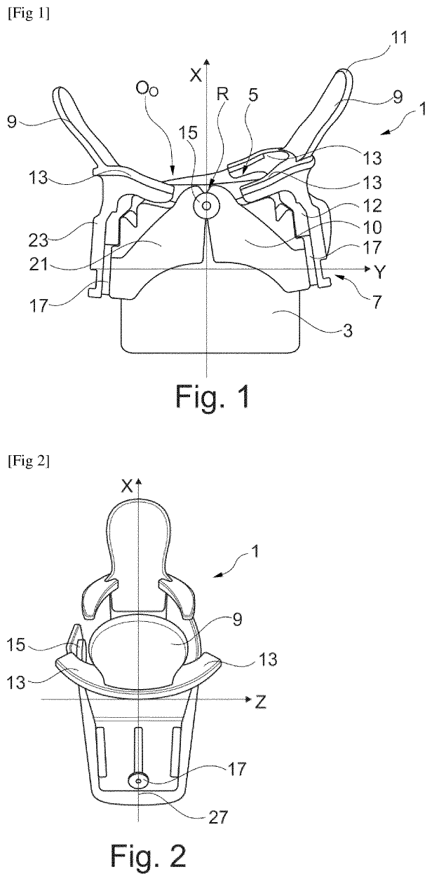

FIG. 1 shows a spacer 1 according to a first embodiment of the invention. The spacer 1 simultaneously allows the lips of the user to be separated to expose the teeth and to define, optionally in cooperation with an adapter, the position of a camera with respect to the teeth of the user.

The spacer 1 extends along a longitudinal X axis and comprises a tubular portion 3 defining a chamber 5 and a support assembly 7 defining an oral opening Oo intended to open onto the mouth of the user in the service position.

The function of the spacer 1 is to define a spacing between an image acquisition device and the oral opening Oo. Advantageously, in the service position, the representations (images or 3D models) acquired by the acquisition device are acquired at a predetermined distance from the teeth of the user. Preferably, the spacer 1 is configured so that this spacing is constant.

The cross-section of chamber 5, in a cross-sectional plane perpendicular to the X axis, may be constant or variable along the X axis. The tubular portion 3 may notably have the general shape of a cylindrical tube, for example with a circular, oval or polygonal cross-section, for example rectangular, or a frustoconical tube. The front and/or rear ends of the tubular portion 3 may be beveled.

Preferably, in a portion of the chamber extending over more than 70%, more than 80%, more than 90%, more than 95%, more than 99%, preferably 100% of the length of the chamber, the spacer has an inner surface that is smooth to the touch, free of protruding edges and/or free of re-entrant edges, and in particular free of projections, a portion of the chamber being a fraction of the chamber delimited by two planes perpendicular to the X axis.

The length of the tubular portion 3 of the spacer 1, measured along the X axis, is preferably greater than 3 cm, 4 cm or 5 cm, and/or less than 25 cm, 15 cm, 10 cm, 8 cm or 7 cm.

The width of the tubular portion 3, that is, its largest dimension in a transverse plane considering all transverse planes along the X axis, is preferably greater than 2 cm and/or less than 9 cm.

Preferably, the thickness of the tubular portion of the spacer is constant, being in particular greater than 0.5 mm or 1 mm and/or less than 8 mm or 5 mm.

Preferably, the tubular portion 3, and more preferentially the entire spacer 1, is made of an opaque material.

The tubular portion 3, preferably the entire spacer 1, is advantageously made of a rigid material, preferably a polymer, for example polyethylene PE, polyethylene terephthalate PET, polystyrene PS or polypropylene PP, preferably polycarbonate PC, advantageously opaque and sterilizable.

The tubular portion 3, preferably the entire spacer 1, is preferably made of a recyclable material, for example a thermoplastic material, cardboard, bamboo fibers, etc. The material may advantageously be biodegradable.

The tubular portion 3 is advantageously non-deformable, that is, having sufficient rigidity so that the tubular portion does not deform during normal use, in particular when the user squeezes the spacer in the service position. Advantageously, no appreciable deformation is detectable to the naked eye when a user squeezes the tubular portion in his hands.

The oral opening Oo is designed to open onto the mouth of a user when the spacer is positioned in the service position.

According to a first embodiment shown in FIGS. 1 to 4, the spacer 1 comprises a tubular portion 3 and a support assembly 7 attached to the tubular portion 3. The support assembly 7 comprises two first parts 10, 21 and two second parts 12, 23, all of these parts preferably being rigid. The first parts 10, 21 are attached to the tubular portion 3 by a Z-axis pivot connection 15. The second parts 12 and 23 are respectively attached to the first parts 10 and 21 by second pivot connections 17 and comprises edges 13 defining the oral opening in the service position and wings 9 projecting beyond the oral opening.

The wings 9 extend from the oral opening Oo, preferably outside a theoretical tube extending the tubular portion 3 beyond the oral opening in the rest configuration, and terminate at a free end 11, preferably rounded for optimum comfort.

The wings 9 are configured to retract the cheeks of the user.

The edges 13 are designed to be inserted between the lips and the teeth of the user. Advantageously, the lips can thus be separated so as not to obstruct the oral opening Oa. Additionally, the edges 13 facilitate retention of the spacer 1 in the mouth of the user.

The edges 13 can be made of an elastomer material or coated with such a material for optimum comfort.

Preferably, each second part 12, 23 of the support assembly 7 comprises two edges 13, one designed to be inserted between the upper lip and the teeth of the user and the other between the lower lip and the teeth.

Advantageously, the edges 13 do not form a continuity of material and, in particular, the edges 13 do not comprise material in a central section around the longitudinal axis. Thus, the edges 13 are configured so as not to be inserted between the lips and the incisors of the user.

This advantageously protects the labial frenum when the spacer is moved laterally in the mouth of the user: in the absence of an edge, no part of the spacer comes into contact with the labial frenum. In addition, the absence of an edge in the central part of the spacer makes it easier to keep the spacer in the mouth in the service position, notably by minimizing the discomfort generated by the presence of a foreign body between the incisors and the lips.

The support assembly 7 is thus attached to the tubular portion 3 by a Z-axis pivot connection 15, allowing the wings 9 to rotate between a rest configuration, wherein the distance between the free ends 11 of the wings 9 is at its maximum, and a contracted configuration, wherein the distance between the free ends 11 of the wings 9 is reduced.

The free ends 11 of the wings are therefore mobile in rotation about the pivot connection 15, which represents the center of rotation R of the free ends.

Advantageously, the center of rotation R is positioned close to the teeth of the user in the service position. For this purpose, it is placed in the immediate vicinity of the oral opening Oo, preferably less than 1 cm away. The distance measured along the longitudinal axis between the center of rotation and the edges 13 is therefore small, preferably less than 1 cm. In the service position of the spacer, the center of rotation R is located between the lips of the user in this embodiment.

Such a configuration advantageously makes it easier to keep the wings in the mouth of the user. If the pivot connection 15 and therefore the center of rotation R of the free ends 11 is far from the teeth of the user, the wings 9 will have a reduced range of movement and will more easily tend to move out of the mouth of the user, particularly in the event of lateral displacement of the spacer in the mouth of the user.

Preferably, the spacer 1 comprises abutments that delimit the range of movement of the wings 9 with respect to the tubular portion 3. The abutment of the rest configuration is preferably formed by the outer surface of the tubular portion 3 against which the first parts 10, 21 come into contact. The abutment limiting the convergence of the wings 9 is preferably achieved by contact between a front end of the tubular portion 3 and an inner surface of the first parts 10, 21.

The spacer 1 comprises an elastic return member which exerts a return force on the first parts 10, 21 and/or on the second parts 12, 23 of the support assembly 7, the return force tending to maintain the support assembly 7 in its rest configuration. The elastic return member may comprise any known means such as one or more elastic bands arranged around or attached to the second parts 12, 23 and/or the first parts 10, 21 and/or the tubular portion 3, one or more magnets or a return spring connecting the first parts 10, 21 to each other or to the tubular portion 3, or connecting the second parts 12, 23 to each other or to the tubular portion 3.

Preferably, the first two parts 10, 21 can be rotated around the same pivot connection 15, but each assembly can also be attached to the tubular portion 3 by its own pivot connection.

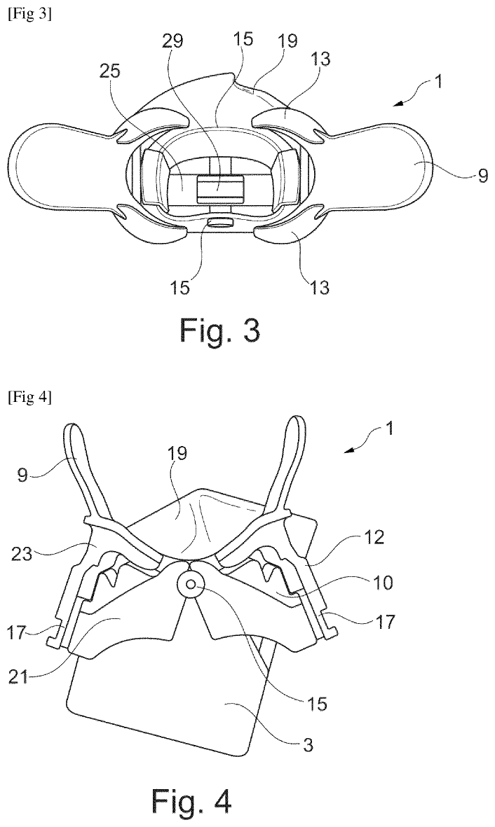

In the example shown, the pivot connection 15 comprises two contact points aligned between the first parts and the tubular portion arranged diametrically opposite on the tubular portion, as more particularly seen in FIG. 3.

Alternatively, the first parts 10, 21 are configured to minimize light ingress between the tubular portion and the wings. To this end, the first parts 10, 21 can be shaped to cover the free spaces between the tubular portion and the wings and can be opaque. Advantageously, the first parts 10, 21 are configured to form a support for the lips of the user in the service position of the spacer.

Preferably, a guard 19 is arranged between the edges 13 and the tubular portion 3 so as to at least partially cover the pivot connection 15 and/or the parts of the spacer 1 likely to come into contact with the mucous membranes of the user. As the assembly 7 is elastically movable with respect to the tubular portion 3, the guard 19 protects the mouth of the user from being pinched between the assembly 7 and the tubular portion 3.

The guard 19 is advantageously made of an elastomer material.

FIG. 1 shows the spacer 1 in the rest configuration, with the wings 9 being in a maximum position of separation. FIG. 4 shows the spacer 1 in a partially contracted configuration, with one wing displaced towards the other wing. The movement of the wings 9 with respect to the tubular portion 3 around the pivot connection 15 makes it easier for the user to insert the spacer into his mouth by bringing the wings closer together and reducing the distance between the free ends 11 thereof. The elastic return member, which tends to return the wings to their rest configuration, allows said wings to exert pressure on the inside of the cheeks of the user. This provides a clear view of the teeth.

In addition, the spacer according to the invention can easily be moved laterally in the mouth of the user to allow side view shots: the flexibility in the position of the wings makes it easier to maintain them in the mouth. This improves the use of the spacer 1 with respect to a spacer comprising fixed and rigid wings and therefore no flexibility of movement with respect to the tubular portion. Lateral displacement of such a spacer is likely to cause at least one wing to move out of the mouth of the user.

The wings 9 may be rigid or flexible. If they are flexible, the wings are advantageously configured to have a flexibility such that, in the service position, they provide sufficient resistance to the force exerted by the cheeks of the user so that the field of view of the image acquisition device is not obscured by the cheeks. Flexible wings provide superior user comfort.

According to an alternative embodiment of the invention, the wings 9 are elastically movable with respect to the tubular portion 3 solely by means of the pivot connection 15. In other words, the spacer does not comprise second pivot connections 17. In this case, the support assembly 7 preferably comprises two one-piece parts, each part being connected to the tubular portion 3 by the pivot connection 15 and comprising a wing 9 and edges 13.

However, each wing 9 is preferentially elastically movable with respect to the tubular portion 3 by means of second pivot connections 17 whose axes of rotation are within the plane defined by the X and Y axes. Preferably, the axes of the second pivot connections 17 are coincident with the Y axis in the rest configuration of the spacer.

Thus, the wings 9 can be moved with respect to the tubular portion 3 by rotating the first parts 10, 21 around the X axis and by rotating the second parts 12, 23 around the axes of the second pivot connections 17.

Advantageously, the movement of the wings 9 with respect to the tubular portion 3 around the axes of the pivot connections 17 greatly improves the user comfort of the spacer, notably for acquiring images according to a plurality of different viewing angles. The tubular portion 3 of the spacer 1 in the service position can be easily moved up and down by the user without significant displacement of the wings 9 in the mouth of the user. The quality of the images acquired is also improved.

Preferably, the second pivot connections 17 are arranged close to the oral opening Oo, for example at a distance less than or equal to 3 cm, 2 cm or 1 cm. This gives the image acquisition device an optimum view of the inside of the mouth of the user and facilitates the movement of the tubular portion 3 with respect to the wings in the service position of the spacer.

The spacer 1 may optionally comprise an acquisition opening Oa arranged on the tubular portion on the opposite side to the oral opening and preferably coaxial therewith. In one embodiment, the chamber 5 only opens outwardly via the oral opening Oo and acquisition opening Oa.

According to one embodiment of the invention, the tubular portion 3 comprises a fastener adapted to engage, in an acquisition position, with an image acquisition device or with an adapter to which a mobile phone is attached in order to hold the mobile phone in position. The fastener is preferably configured to retain its shape when used for said fastening, making it more reliable. It is preferably formed by a recess and/or a bead of material, preferably on the outer surface of the tubular portion. The distance between the fastener and the acquisition opening is preferably less than 3 cm, preferably less than 2 cm, preferably less than 1 cm, preferably less than 0.5 cm.

According to an advantageous variant shown in FIGS. 1 to 4, the tubular portion 3 comprises a hollow passage 25 configured to allow the insertion of an image acquisition device. The hollow passage 25 preferably extends in a direction perpendicular to the X axis, preferably along a diameter of a cross-section of the tubular portion 3. It can take the form of a tube comprising at least one opening 27 arranged on the outer surface of the tubular portion 3 for insertion of the image acquisition device. The hollow passage 25 comprises a window 29 facing the oral opening so as not to obscure the field of view of the image acquisition device towards the mouth of the user.

The hollow passage 25 may alternatively comprise two or more windows 29 to implement two or more image acquisition devices simultaneously. The hollow passage 25 may also comprise a single window 29 of sufficient size to implement two or more image acquisition devices.

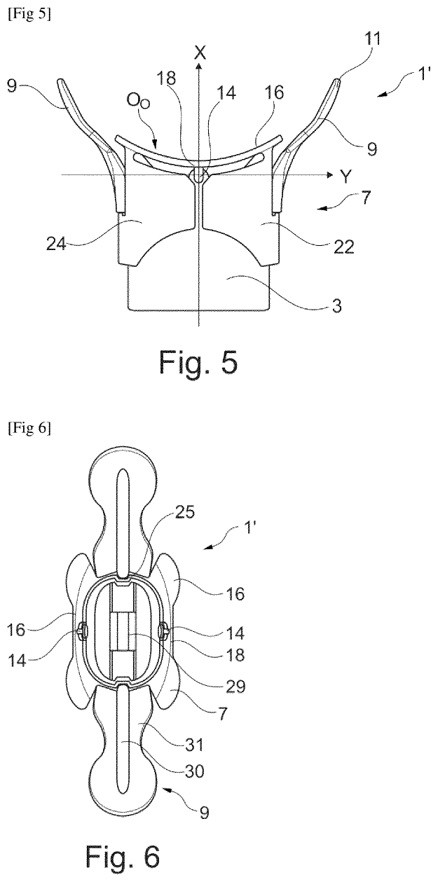

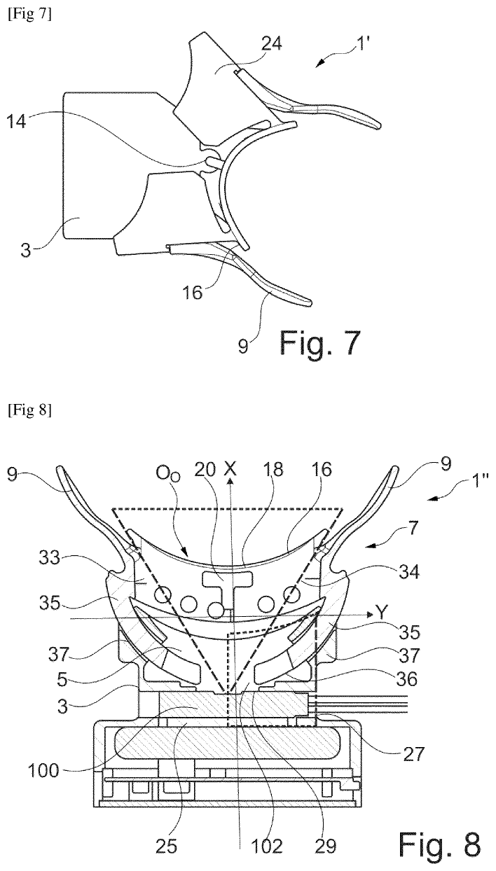

FIGS. 5 to 7 show a second embodiment of the spacer according to the invention.

The spacer 1′ comprises a tubular portion 3 which may have the features of the tubular portion 3 of the spacer 1 described previously.

The spacer 1′ also comprises a support assembly 7, preferably in one piece. The assembly 7 comprises edges 16 and two parts 22, 24, each comprising a wing 9. The parts 22, 24 are connected together only by the edges 16 designed to be placed between the teeth and the lips of the user in the service position. The edges 16 are attached to the tubular portion 3 by one or more connections 14.

Advantageously, the spacer 1′ forms a one-piece assembly. The shape continuity of the spacer 1′ prevents a lip or part of the mouth of a user from being pinched by moving parts of the spacer.

A connection 14 is made, for example, by a stud integral with an edge 16 arranged in an opening in the outer surface of the tubular portion 3.

Preferably, the connection 14 is located in the immediate vicinity of the edges 16, notably less than 1 cm, 0.5 cm or 0.3 cm away.

The edges 16 are configured to be elastically deformable. The force exerted by the user on the wings 9 deforms the edges 16 and bends them in the direction of the X axis, bringing the free ends 11 of the wings 9 closer together.

This therefore allows a rotational movement of the free ends 11 around the center of rotation R. FIG. 16 shows a superimposition of two configurations of the spacer 1′, showing the movement of the free ends 11 of the wings and the position of the center of rotation R. The center of rotation R is advantageously located in front of the oral opening Oo, that is, outside the spacer 1′, in a space between the wings 9 and the edges 16. In the service position, the center of rotation R is located in the mouth of the user.

Positioning the center of rotation R close to the oral opening facilitates the rotational movement of the wings and also minimizes the risks of the wings accidentally moving out of the mouth of the user, particularly when the spacer is moved inside the mouth.

Preferably, the edges 16 are rigid with the exception of a flexible section 18 extending on both sides of the connection 14 along the Y axis and whose length along the Y axis is less than 3 cm, 2 cm or 1 cm and/or greater than 0.5 cm, 1 cm or 2 cm.

Preferably, the edges 16 comprise a flexible section 18 of reduced thickness so as to increase the flexibility of this section in the direction of folding of the edges. The thickness is advantageously reduced as measured along the X axis or along a radial direction from the longitudinal X axis. The thickness of the flexible section may be less than 50%, 30% or 10% of a maximum thickness of the edges 16. Preferably, the section of reduced thickness extends on both sides of the longitudinal axis, notably close to the connection 14.

Advantageously, the reduced thickness of the flexible section in the central part of the spacer protects the labial frenum when the spacer is moved laterally in the mouth of the user: as the thickness of the edge is reduced in this section, the lips are separated by the lateral sections of the edge 16 and no part of the spacer comes into contact with the labial frenum. In addition, this makes it easier to maintain the spacer in the mouth in the service position, notably by minimizing the discomfort generated by the presence of a foreign body between the incisors and the lips.

According to an advantageous variant, the support assembly comprises an elastic return member adapted to increase the return force tending to maintain the wings in the rest configuration. The elastic return member may notably be an elastic band arranged around the two parts 22, 24 or connecting the two parts 22, 24, a return spring connecting the two parts 22, 24 or even a coating of the flexible section 18 or at least one element arranged between the flexible section 18 and the two parts 22, 24, the coating or the at least one element preferably being made of elastic material, in particular elastomer.

According to one variant, the two parts 22, 24 are configured to minimize light ingress between the tubular portion and the wings. Both parts can be shaped to cover the free spaces between the tubular portion and the wings and can be opaque. Advantageously, the parts 22, 24 are configured to form a support for the lips of the user in the service position of the spacer.

As in the first embodiment described previously, the wings 9 can be rigid or flexible.

FIG. 6 shows wings 9 comprising a core 30 in the form of a wing rod and covered by a layer 31 of material defining the shape of the wings.

As can notably be seen in FIG. 6, the edges of the wings may have a shape curved inwardly of the wings. The wings 9 thus comprise a section of reduced width, designed to be housed between the teeth and the corners of the mouth of the user in the service position of the spacer. Advantageously, the presence of a section of reduced width facilitates the successive insertion of the wings into the mouth: the stresses exerted by the first wing placed in the mouth on the perimeter of this latter are minimized with respect to a wing whose edges are rectilinear, facilitating the placement of the second wing in the mouth. In addition, the retention comfort of the spacer in the mouth is improved by this geometry of the wings.

The support assembly 7, notably the edges 16, can be made of polypropylene, polycarbonate or another material having a low Young's modulus, notably less than 5 GPa, 3 GPa or 1 GPa.

The support assembly 7 is thus configured to allow elastic mobility of the wings 9 between the rest configuration and a contracted configuration, wherein the edges 16 are folded to bring the edges closer together. The edges 16 are elastically deformable and therefore allow the wings 9 to exert pressure on the inside of the cheeks of the user in the service position of the spacer 1′.

According to an alternative embodiment not shown, the wings 9 are each attached to parts 22, 24 by a pivot connection whose axis lies in the plane defined by the X and Y axes. Preferably, these pivot connections are identical to the second pivot connections 17 described with reference to the first embodiment.

FIGS. 8 to 13 show a third embodiment of the spacer according to the invention. As shown, the spacer 1″ comprises a tubular portion 3 and a support assembly 7 attached to the tubular portion 3.

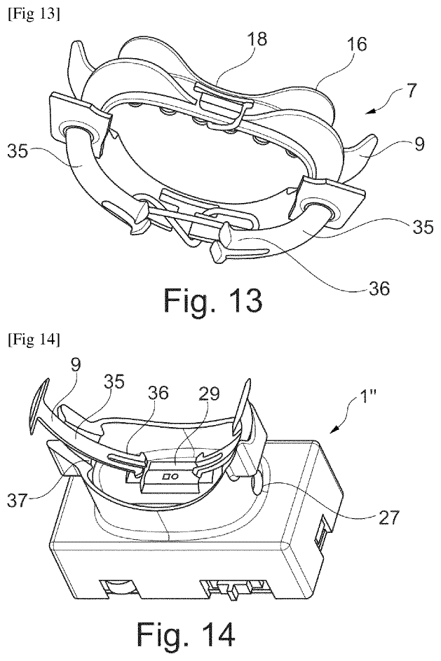

The support assembly 7, shown separately in FIG. 13, comprises edges 16 and two parts 33, 34 each comprising a wing 9. The two parts 33, 34 are connected only by the edges 16, which comprise a flexible section 18 allowing elastic deformation of the support assembly 7 so as to bring the free ends 11 of the wings 9 closer together.

According to one variant, the two parts 33, 34 are configured to minimize light ingress between the tubular portion and the wings. Both parts can be shaped to cover the free spaces between the tubular portion and the wings and can be opaque. Advantageously, the parts 33, 34 are configured to form a support for the lips of the user in the service position of the spacer.

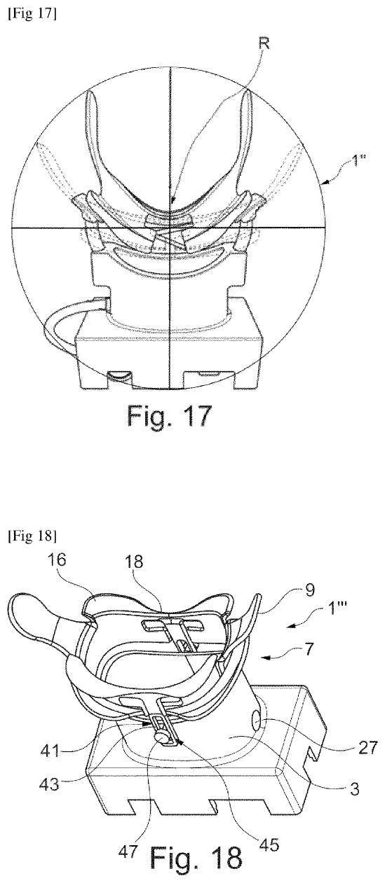

FIG. 17 shows a superimposition of two configurations of the spacer 1″, showing the movement of the free ends of the wings about the center of rotation R. As in the embodiment of FIG. 16, the center of rotation R is advantageously arranged in front of the oral opening Oo, that is, outside the spacer 1′, in a space between the wings 9 and the edges 16. In the service position, the center of rotation R is located in the mouth of the user.

Positioning the center of rotation R close to the oral opening facilitates the rotational movement of the wings and also minimizes the risks of the wings accidentally moving out of the mouth of the user, particularly when the spacer is moved inside the mouth.

Advantageously, an elastic material, preferably an elastomer, can be arranged in the openings 20 of the assembly 7 made between the flexible sections 18 and the two parts 33, 34. The elastic material acts as an elastic return member and is configured to increase the return force tending to maintain the wings in the rest configuration. Other elastic return members can be used alternatively or in combination, such as those previously described with reference to the second embodiment.

Each part 33, 34 of the support assembly 7 comprises, opposite the wings 9 along the X axis, two projecting curved rods 35 configured to engage with the tubular portion 3 to attach the assembly 7 to the tubular portion.

Preferably, the rods 35 have a circular arc shape curved in the direction of the longitudinal axis X and define a circular sector with an angle of between 60° and 90°.

Of course, the rods 35 can be of any arc shape.

In the embodiment shown, the rods 35 extend mainly in the plane defined by the X and Y axes, which is also the plane wherein the wings 9 mainly extend. However, the rods 35 may be arranged to extend mainly in any plane comprising the X axis.

The tubular portion 3 defines the chamber 5 and comprises a hollow passage 25 passing through the chamber 5. The hollow passage 25 is configured to allow the image acquisition device 100 to be inserted through the lateral openings 27 arranged on the outer surface of the tubular portion 3. A window 29 in the hollow passage 25 facing the oral opening Oo of the spacer 1″ is provided so as not to obscure the field of view 102 of the image acquisition device 100.

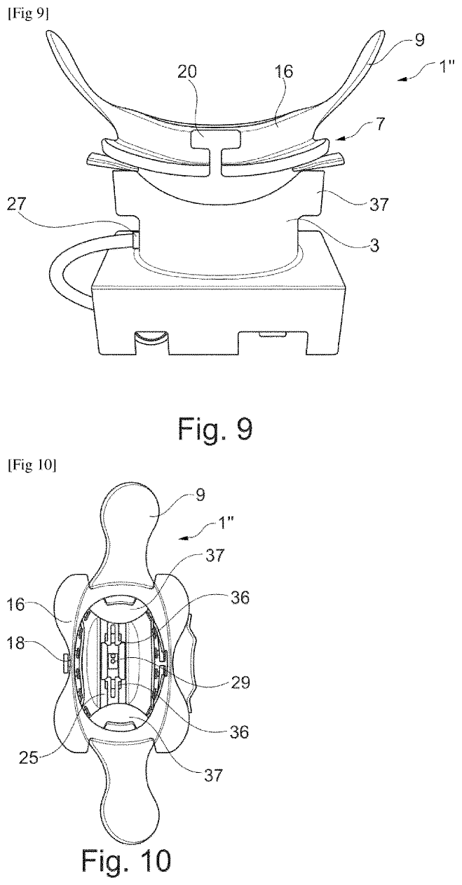

The tubular portion 3 also comprises housings 37 configured to engage with the rods 35 of the support assembly 7. The housings 37 pass through the wall of the tubular portion 3 and preferably extend into the chamber 5. The rods 35 can be inserted into the housings 37 until they reach the chamber 5 in order to attach the support assembly 7 to the tubular portion 3. In the rest configuration of the spacer 1″ shown in FIGS. 8 and 9, the rods 35 are fully inserted in the housings 37.

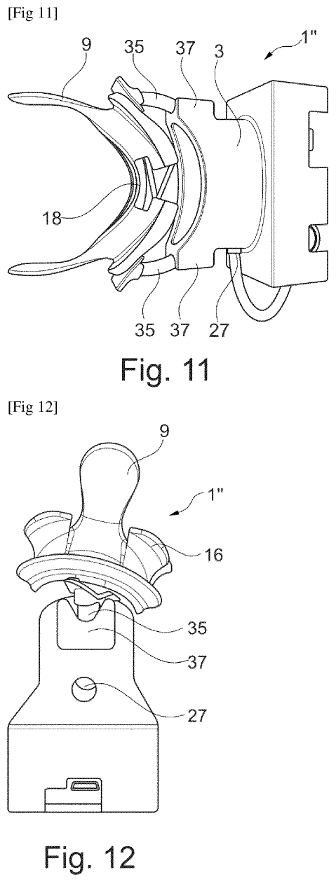

Advantageously, the rods 35 can slide into the housings 37. This allows the user to bring the wings 9 closer together by elastically deforming the edges 16 of the assembly 7, as shown in FIG. 11.

When the edges are brought together, the rods 35 extend partly out of the housings 37. Advantageously, this allows a rotation of the assembly 7 with respect to the tubular portion 3 around the Z axis and thus allows the user to modify the field of view of the image acquisition device without modifying the position of the support assembly 7 in the mouth of the user. This improves user comfort and the quality of the shots.

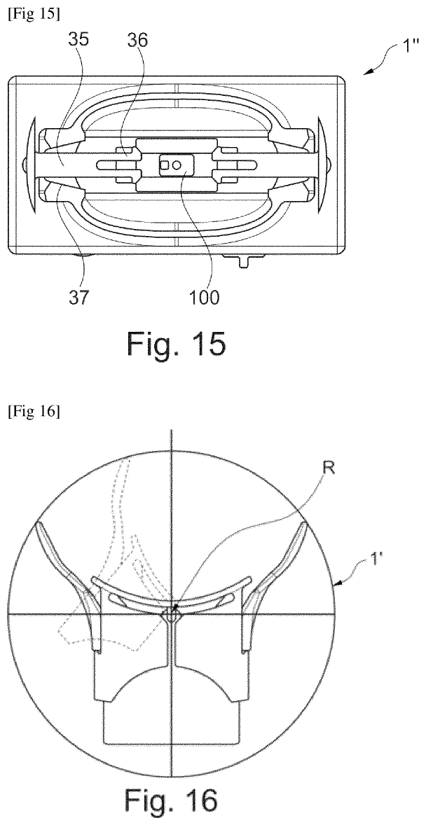

According to one advantageous variant, the rods 35 are not fully inserted into the housings 37 in the rest configuration. They therefore extend partly outside the housings 37. This makes a displacement of the assembly 7 along a rotational movement around the Z axis with respect to the tubular portion 3, without elastic deformation of the wings of the assembly 7. This relative movement is achieved by sliding the rods 35 in the housings 37 and allows the field of view of the image acquisition device to be modified without modifying the position of the support assembly 7 in the mouth of the user. As more particularly seen in FIG. 14 and FIG. 15, the housings 37 may have a flared shape, having a smaller diameter on the outer surface of the tubular portion 3 than their diameter on the inner surface of the tubular portion 3. Thus, the walls of the housings 37 are configured to fit the rods 35 at the outer surface of the tubular portion with a small clearance, for example less than 0.5 mm or 0.3 mm, and to leave a larger clearance at the inner surface of the tubular portion, for example greater than 1 mm or 2 mm, so that the rods 35 can pivot in the housings 37, thus allowing rotational movement along the Y axis of the support assembly 7 with respect to the tubular portion 3. This rotational movement around the Y axis is shown in FIG. 12.

Alternatively or in combination, the rods 35 are flexible so that their elastic deformation allows the support assembly 7 to be moved with respect to the tubular portion 3 along a rotational movement around the Y axis. This relative movement allows the user to take images from several view points without having to move the support assembly 7 too much in his mouth.

According to an advantageous variant, the rods 35 comprise a slotted end 36 defining two branches. Each slotted end 36 therefore comprises two branches, or free ends, separated by a slot. The branches are elastically deformable and are configured to be spaced apart in their rest configuration. They can be elastically deformed to bring them together, preferably to bring them into contact.

To insert the rods 35 into the housings 37, the free ends of each slotted end 36 are brought together so as to be able to enter the housings 37. When insertion is complete, the ends 36 are arranged in the chamber 5 and the slotted ends are in their rest configuration, with the branches spaced apart from each other. The distance between the free ends of the slotted ends is defined so that a circle circumscribing the free ends has a diameter greater than a minimum diameter of the housings 37: thus, the slotted ends act as an abutment against the inner wall of the housings 37 when the rods are removed from the housings 37, preventing removal of the support assembly 7 in the absence of a consequent external force.

Advantageously, the slotted ends are configured so that the slots, that is, the distance between the branches, are wide enough not to obscure the field of view of the image acquisition device 100 regardless of the position of the rods 35 in the housings 37.

According to an advantageous variant, two or more image acquisition devices can be used. In this case, care is taken to ensure that the slots at the slotted ends of rods 35 are wide enough not to obstruct the fields of view of all the image acquisition devices.

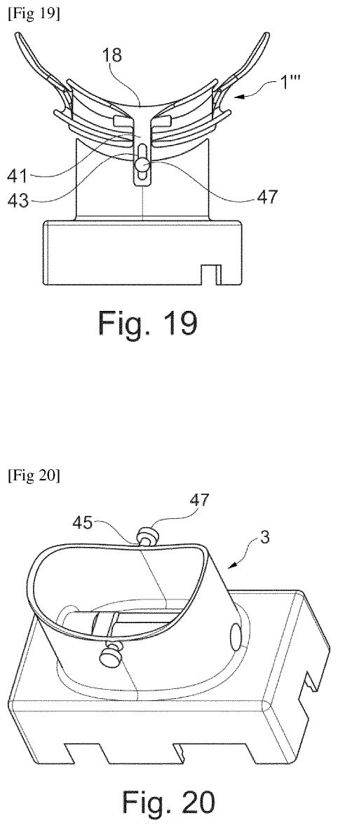

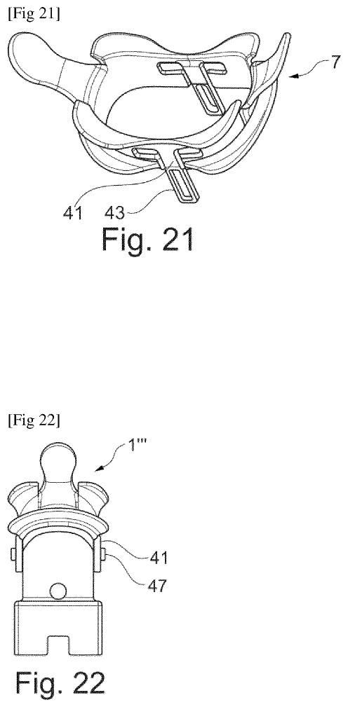

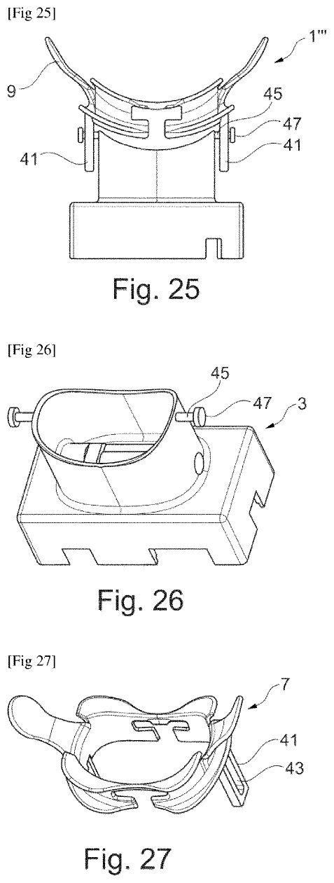

FIGS. 18 to 23 show a fourth embodiment of the spacer according to the invention. FIGS. 24 to 29 show a variant of the fourth embodiment.

As shown, the spacer 1″′ comprises a tubular portion 3 and a support assembly 7 attached to the tubular portion 3. The fastening between these two elements differs from that of the third embodiment. Indeed, the support assembly 7 comprises two attachment rods 41 extending towards the tubular portion, each rod comprising a through-opening 43, preferably rectangular in shape. The openings 43 of the attachment rods 41 engage with two attachment pins 45 of the tubular portion 3, the attachment pins 45 being inserted into the openings 43 to attach the support assembly and the tubular portion.

In a variant of the fourth embodiment shown in FIGS. 18 to 23, the attachment rods are arranged diametrically opposite on a circumference of the support assembly, and are offset by 90° on the circumference of the support assembly with respect to the wings 9. Thus, the wings 9 are aligned on a straight line parallel to the Y axis, and the attachment rods 41 are aligned on a straight line parallel to the Z axis.

In a variant of the fourth embodiment shown in FIGS. 24 to 29, the attachment rods 41 are arranged diametrically opposite on a circumference of the support assembly 7 and extend towards the tubular portion 3 in continuity with the wings 9. Thus, the wings 9 and the attachment rods 41 are all aligned on a straight line parallel to the Y axis.

The attachment rods 41 extend towards the tubular portion 3, preferably parallel to the longitudinal axis.

Advantageously, the attachment rods 41 extend from the flexible section 18 of the support assembly 7 towards the tubular portion 3 as shown in FIGS. 18 to 23.

The attachment pins 45 can be arranged on the outer surface of the tubular portion 3 as shown in FIGS. 18 to 29, which advantageously frees up the field of view of the image acquisition device inside the tubular portion, but the pins could also be arranged on the inner surface of the tubular portion 3.

Advantageously, the attachment pins 45 each comprise a cylindrical main section inserted in the openings of the attachment rods and a cylindrical free end 47 whose diameter is greater than the width of the openings 43.

Advantageously, the free ends 47 improve the retention of the support assembly on the tubular portion.

Preferably, to allow insertion of the attachment pins 45 into the openings 43, the attachment rods 41 are made of an elastically deformable material with a Shore A hardness of between 50 and 100, preferably between 65 and 80. This makes it easy to insert the free ends 47 into the openings 43 while at the same time allowing the pins to be maintained effectively in the openings. After insertion, the openings 43 return to their initial shape.

FIGS. 20 and 21 and FIGS. 26 and 27 separately show the tubular portion 3 and the support assembly 7 of the spacer 1″′ according to the two alternative positions of the attachment rods.

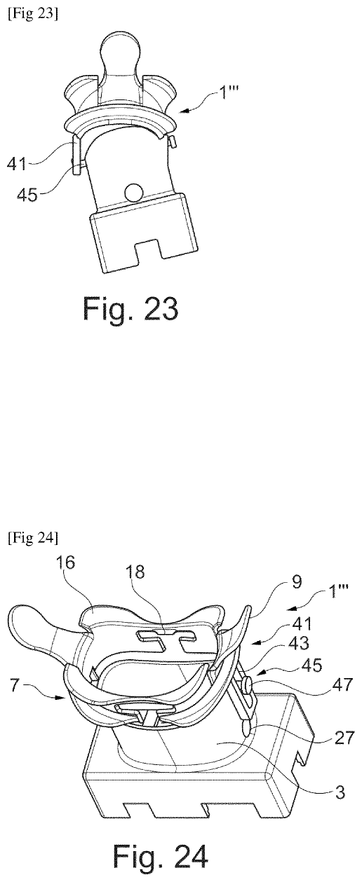

FIGS. 22 and 23 respectively show the first variant of the spacer 1″′ in a rest configuration wherein the main axis of the support assembly is aligned with the main axis of the tubular portion and in a rotational configuration wherein the support assembly 7 is rotated with respect to the tubular portion 3 around the Y axis.

As can be seen in FIG. 23, the attachment pins 45 do not prevent this rotation of the support assembly 7 as the openings 43 in the attachment rods 41 are long enough to allow the attachment pins 45 to move through these openings in the direction in which the attachment rods extend. The openings 43 can have a length greater than 1 cm or 1.5 cm and/or less than 3 cm or 2 cm, and a width. The free ends 47 can have a diameter of between 1.1 and twice the width of the openings 43.

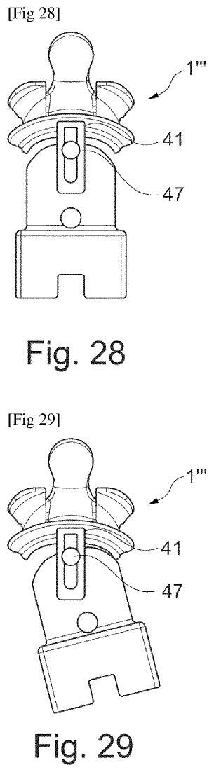

FIGS. 28 and 29 respectively show the second variant of the spacer 1″′ in a rest configuration wherein the main axis of the support assembly is aligned with the main axis of the tubular portion and in a rotational configuration wherein the support assembly 7 is rotated with respect to the tubular portion 3 around the Y axis.

### Operation

The operation of the spacer follows directly from the foregoing description.

Initially, the spacer may or may not be in a disassembled position, that is, the support assembly may or may not be attached to the tubular portion. If the spacer is disassembled, the user attaches the support assembly 7 to the tubular portion 3, for example by inserting the rods 35 into the housings 37 in the case of the third embodiment or by clipping the studs of the assembly 7 into a complementary housing of the tubular portion 3 in the case of the second embodiment.

If the spacer does not comprise its own image acquisition device, an external image acquisition device, in particular a mobile phone comprising such a device, is attached to the spacer. Alternatively, both the spacer and the image acquisition device can be attached to an adapter configured to accommodate these two elements.

The spacer is then in the rest configuration. In this configuration, the user cannot insert the two wings in his mouth.

The user then presses the two wings together by virtue of the elastic deformation of the support assembly. The spacer is then in a contracted configuration. In this configuration, the user can then insert the wings 9 and the edges 16 between his lips and his teeth. After this insertion, the user releases the pressure on the wings. The spacer then tends to return elastically to the rest configuration. However, this return is hampered by the action of the cheeks on the wings, and by the action of the central parts of the lips and the corners of the mouth on the edges. These elastic actions effectively separate the cheeks and lips from the teeth, thus allowing the image acquisition device to have an unobstructed view of the teeth.

Additionally, the elasticity allows the spacer to adapt to the user's morphology, so that the spacer can be available in just one size for the entire population.

The user then positions the oral opening Oo and/or the image acquisition device in front of the teeth for which he wants to acquire one or more 2D or 3D representations, preferably taking photos or acquiring a scan. The spacer is then in a service position.

By pressing the shutter button of the image acquisition device, the user acquires a 2D or 3D representation.

If required, the user then moves the support assembly with respect to the tubular portion to acquire 2D or 3D representations in other orientations of the image acquisition device with respect to the teeth of the user. In particular, by rotating the tubular portion around the user, the image acquisition device can observe different regions of the mouth of the user, for example to take photos of the dental arch or the teeth at the back of the mouth.

The user can also move the support assembly in his mouth. To facilitate this movement, the user can advantageously squeeze the wings towards one another again, to contract the support assembly.

Preferably, the user acquires 2D or 3D representations by acquiring at least a front view, a right view and a left view.

The spacer does not prevent the user's jaws from moving toward or away from one another. It thus allows the acquisition of photos showing the user's teeth, with the mouth open or closed, while keeping the lips curled up.

Preferably, the user acquires 2D or 3D representations by acquiring at least one open-mouth view and at least one closed-mouth view, preferably for front, right and left views in each case.

The user then removes the spacer from his mouth, and may or may not disassemble the support assembly and the tubular potion, and if applicable the adapter and/or the image acquisition device.

Of course, the order of operations can be changed. For example, the user can attach the spacer to the adapter before or after attaching the image acquisition device to the adapter. The spacer can be removed before or after the adapter or the image acquisition device.

As is now clear, the invention limits the risk of acquiring photos or 3D models with a spacer that is unsuitable for the user.

The spacer allows fast acquisition according to different viewing angles, under excellent conditions of hygiene and comfort, typically in under five minutes, without the need for a specialist, such as a dentist or an orthodontist. In particular, acquisition can be carried out by the user himself or by one of his family members, using a simple mobile phone, anywhere, and in particular outside a medical, dental or orthodontic practice. Additionally, acquisition is possible without the use of a tool that rests on the ground to immobilize the mobile phone, and in particular without a tripod.

The invention is not limited to the examples just described; in particular, features of the examples shown can be combined with each other in variants not shown.

For example, rather than a flexible edge 16, the third embodiment may comprise a pivot connection mechanism as described with reference to the first embodiment. It may also comprise second pivot connections as described with reference to the second pivot connections 17 of the first embodiment, allowing rotation of the wings along a second axis.

Any embodiment of a spacer according to the invention may also comprise a fastening mechanism between the support assembly and the tubular portion as described with reference to the third embodiment.

Other variants and improvements can be envisaged without departing from the scope of the invention.

1. A spacer for acquiring 2D or 3D representations of teeth of a user with an image acquisition device, comprising:
a tubular portion having a longitudinal axis (X), and
a support assembly attached to the tubular portion, comprising at least one edge defining an oral opening and at least two wings comprising free ends for separating the cheeks of a user,
the support assembly being elastically deformable when pressure is applied to the wings in the direction of the longitudinal axis (X) so as to rotate the free ends about a center of rotation, the support assembly being deformable between a rest configuration wherein the distance between the free ends of the wings is at its maximum and a contracted configuration wherein the distance between the free ends of the wings is less than that of the rest configuration,
the center of rotation of the free ends being located, in the rest configuration, at a distance from the edge, measured in a direction parallel to the longitudinal axis, of less than or equal to 2 cm, preferably less than or equal to 1 cm or 0.5 cm.

2. The spacer according to claim 1, the support assembly comprising at least two parts each supporting a wing and attached to the tubular portion by a first pivot connection allowing a relative movement of the wings with respect to the tubular portion.

3. The spacer according to claim 2, the support assembly comprising two first parts attached to the tubular portion by the first pivot connection and two second parts each attached to a first part by a second pivot connection allowing a relative movement between the first parts and the second parts, the second parts supporting the wings, the first and second parts each preferably being one-piece.

4. The spacer according to claim 1, the support assembly comprising two parts each supporting a wing, the at least one edge connecting the two parts and comprising a flexible section configured to be elastically deformable when pressure is applied to the wings in the direction of the longitudinal axis, the edge preferably having a reduced thickness in the flexible section.

5. The spacer according to claim 1, the support assembly comprising an elastic return member configured to increase the rigidity of the flexible section, the elastic return member preferably being a member made of elastomer.

6. The spacer according to claim 1, the support assembly comprising rods configured to be inserted and to slide into housings of the tubular portion.

7. The spacer according to claim 1, the rods being curved in the direction of the longitudinal axis.

8. The spacer according to claim 6, the rods comprising slotted free ends defining two branches.

9. The spacer according to claim 1, the support assembly being one-piece.

10. The spacer according to claim 1, the wings comprising a core covered with a layer.

11. The spacer according to claim 1, the tubular portion comprising a hollow passage configured to receive an image acquisition device in an acquisition position wherein the image acquisition device has at least a partial view of the oral opening.

12. The spacer according to claim 1, configured to receive and hold a mobile phone, preferably releasably, optionally via an adapter, the mobile phone being attached to the spacer so that the image acquisition device of the mobile phone has at least a partial view of the oral opening.

13. The method of acquiring a 2D or 3D representation by means of a spacer according to claim 1, said method comprising the following steps:
a) partial insertion, by the user, of the spacer into the mouth of the user to a service position wherein the image acquisition device has a view of the teeth of the user through the oral opening, the wings of the spacer separating the lips of the user to expose said teeth;
b) activation, preferably by the user, of the image acquisition device so as to acquire said 2D or 3D representation;
c) modification of the positioning of the oral opening relative to the user, by
rotation around the user, and/or modification of the position of the tubular portion with respect to the support assembly, then return to step b).
